(19) United States
(12) Patent Application Publication
(10) Pub. No.: US 2005/0046355 A1
(43) Pub. Date: Mar. 3, 2005

(54) Cooling system for flat glass panel of CRT, process for sealing studs on the panel, and apparatus for implementing the process

(76) Inventors: Yang Quanyi, Anyang (CN); Zhou Geng, Anyang (CN); Wang Xianyu, Anyang (CN)

Correspondence Address: HARNESS, DICKEY & PIERCE, P.L.C., P.O. BOX 828, BLOOMFIELD HILLS, MI, 48303, US

(21) Appl. No.: 10/890,374

(22) Filed: Jul. 13, 2004

(30) Foreign Application Priority Data
Jul. 14, 2003 (CN) 03146031.3

(51) Int. Cl. H01J 13/32

(52) U.S. Cl. 315/5.23; 315/112; 315/117

(57) ABSTRACT

The present invention provides a cooling system for the inner surface of a flat glass panel, comprising a supply duct for cooling gas, a cooling gas distributor, and a conveying belt for the flat glass panel, characterized in that the cooling gas distributor is capable of directing cooling gas towards one or more locations on the inner surface of the flat glass panel that are to be in contact with the supporting poles of a stud-sealing machine. The present invention also provides a process for sealing studs on the inner side of the skirt of a flat glass panel and an apparatus for implementing such a process, both employing the cooling system of the invention. The invention makes it possible to decrease the depression ratio and the ratio of crack and rupture of the panel product with sealed studs.

### TECHNICAL FIELD

The present invention relates to a cooling system for the flat glass panel of CRT (cathode ray tube) and its use. In particular, the present invention relates to a cooling system for the inner surface of the flat glass panel of CRT, a process for sealing studs on the inner side of the skirt of a flat glass panel of CRT and apparatus for implementing such a process.

### BACKGROUND ART

The flat glass panel of CRT consists of a substantially rectangular face portion and a skirt portion forming a side wall of the face portion. The face portion includes an inner surface, which is surrounded by the side wall formed by the skirt, and an outer surface, which is on the opposite side of the inner surface. On the inner side, including its corner portion, of the side wall formed by the skirt, it is necessary to seal studs, which are used to secure the shadow mask of the CRT. As the shadow mask of the CRT must be accurately positioned, the precise sealing of the studs onto the inner side of the skirt of the flat glass panel is of great importance to the quality of the final flat glass panel.

In manufacturing a flat glass panel of CRT, after the panel is molded in a mold, it is cooled, and then studs are sealed onto the inner side of its skirt by a stud-sealing machine. The stud-sealing machine comprises, among others, supporting poles designed to support the flat glass panel. For the purpose of sealing studs, the supporting poles of the stud-sealing machine are brought to support the flat glass panel with their tips in contact with the inner surface of the flat glass panel, so as to bear the weight of the panel. The supporting poles are provided with heaters in themselves to heat their tips, which are to be in direct contact with the inner surface of the flat glass panel, thus preventing the flat glass panel from developing crack and rupture due to the low temperature of the tips of the supporting poles. On the other hand, to prevent the inner surface of the flat glass panel from developing depressions where it is in contact with the supporting poles, it must be at a temperature low enough for it to be hard and bear the weight of the panel without deformation. In the prior art, this is achieved by lengthening the duration of time in which the panel is passed from the mold to the stud-sealing machine and simultaneously naturally cooled; however, after such a procedure, when the panel is subjected to the step of sealing studs, it is susceptible to crack and rupture, thus increasing the ratio of the sub-standard products. Therefore, an improved stud-sealing process and the relevant system and apparatus for that purpose will be of significance to the increase of the productivity of the panel product.

### Contents of the Invention

Unexpectedly and surprisingly, the inventors have found that, by locally carrying out forced cooling at the locations on the inner surface of the glass flat panel that are to be in contact with the supporting poles of the stud-sealing machine, it is possible to solve the problem associated with the prior art process, thus increasing the productivity of the panel products with sealed studs. In particular, the present invention makes it possible to shorten the duration of time in which the panel is passed from the mold to the stud-sealing machine and simultaneously cooled, and reduce the chances of the flat glass panel developing depression on its inner surface and developing crack and rupture.

Therefore, in one aspect, the present invention provides a cooling system for the inner surface of the flat glass panel of CRT. In particular, the present invention provides a cooling system for use in sealing studs on the inner side of the skirt of the flat glass panel of CRT, comprising
(1) a supply duct for cooling gas;
(2) a cooling gas distributor; and
(3) a conveying belt for the flat glass panel; characterized in that, the cooling gas distributor is capable of directing the cooling gas towards the locations on the inner surface of the flat glass panel that are to be in contact with the supporting poles of the stud-sealing machine alongside the conveying belt for the flat glass panel is installed a removing belt, which is not coupled to the conveying belt for the flat glass panel; the removing belt is linked with a programmable logic controller (PLC), which receives signals from the removing belt and transmits them to a solenoid; the solenoid turns on or closes the supply duct for the cooling gas; thus, the cooling gas is controlled to effect forced cooling of the flat glass panel at the desired locations on its inner surface with its inner surface facing upward for a period of time.

In another aspect, the present invention provides a process for sealing studs on the inner side of the skirt of the flat glass panel, comprising
(1) carrying out forced cooling at one or more locations on the inner surface of the flat glass panel;
(2) supporting the panel at the one or more locations cooled as in (1) with one or more supporting poles of the stud-sealing machine; and
(3) sealing studs on the inner side of the skirt of the flat glass panel.

In still another aspect, the present invention provides apparatus for sealing studs on the inner side of the skirt of the flat glass panel, comprising
(1) a cooling system;
(2) a conveying belt for the flat glass panel; and
(3) a stud-sealing machine for the flat glass panel;
   characterized in that, the cooling system comprises a cooling gas distributor capable of directing cooling gas towards the locations on the inner surface of the flat glass panel that are to be in contact with the supporting poles of the stud-sealing machine.

### DESCRIPTION OF FIGURES

FIG. 1 represents a schematic view of the cooling system of the invention.

FIG. 2a represents a schematic view of the flat glass panel.

FIG. 2b represents a schematic view of the tip of the supporting pole of the stud sealer.

### MODE OF CARRYING OUT THE INVENTION

The cooling system of the invention for use in sealing studs on the inner side of the skirt of the flat glass panel of CRT comprises
(1) a supply duct for cooling gas;
(2) a cooling gas distributor; and
(3) a conveying belt for the flat glass panel; characterized in that, the cooling gas distributor is capable of directing cooling gas towards the locations on the inner surface of the flat glass panel that are to be in contact with the supporting poles of the stud-sealing machine; alongside the conveying belt for the flat glass panel is installed a removing belt, which is not coupled to, and can thus move independently of the conveying belt for the flat glass panel; the removing belt is linked with a programmable logic controller, which receives signals indicating the position of the flat glass panel and sends the signals to a solenoid to turn on or stop the supply duct for the cooling gas, and to a motor to activate or stop the removing belt; thus, the cooling gas is controlled to effect forced cooling is of the flat glass panel at the desired locations on its inner surface with its inner surface facing upward for a period of time.

In the cooling system of the invention, the cooling gas distributor has at least one, preferably more than three, and most preferably four cooling gas nozzles, which are adjustable to be directed at as many locations on the inner surface of the flat glass panel that are to be in contact with the supporting poles of the stud-sealing machine. The removing belt is installed alongside the conveying belt for the panel, and can move independently of the conveying belt for the panel. If a flat glass panel product is detected with any defect, the removing belt will be activated to remove it from the conveying belt, rather than passing it on the conveying belt to a downstream procedure for further processing. The panel, after cooled with the cooling system of the present invention, is passed on the conveying belt—optionally with the help of an overturning means, which overturns the panel upside down and thus brings it to a state in which its inner surface faces downward—to a stud-sealing machine for sealing studs on the inner side of the skirt of the flat glass panel.

After molding, the flat glass panel is at a high temperature and thus has a low surface hardness on its inner surface. Accordingly, upon molding, it cannot be supported by the supporting poles of the stud-sealing machine; instead, it is put on the conveying belt with its inner surface facing upwards, thus facilitating forced cooling of certain locations on its inner surface with the cooling system of the invention. After subjected to forced cooling, the locations which are to be in contact with the supporting poles become hard enough to bear the weight of the flat glass panel without developing depressions.

The present invention also provides a process for sealing studs onto the inner side of the skirt of the flat glass panel, comprising (1) carrying out forced cooling at one or more locations on the inner surface of the flat glass panel;
(2) supporting the flat glass panel at one or more locations cooled as in (1) with one or more supporting poles of the stud-sealing machine; and
(3) sealing studs onto the inner side of the skirt of the flat glass panel.

In the process of the invention, the step of carrying out forced cooling at one or more locations on the inner surface of the flat glass panel that are to be in contact with the supporting poles of the stud-sealing machine is implemented with the cooling system of the present invention. In the step, forced cooling is carried out at one or more locations, preferably at more than three locations, and most preferably at four locations on the inner surface of the flat glass panel. For each location, the cooling gas nozzle blows cooling gas at a flow rate of 20-90 m³/hour, preferably 35-75 m³/hour, and more preferably 50-60 m³/hour. The cooling gas is usually air and inert gas, including helium, and preferably air. For each flat glass panel, the duration of time for blowing cooling gas is usually less than 10 seconds, preferably 2-10 seconds, and more preferably 3-7 seconds. After the forced cooling is completed, the one or more locations on the inner surface of the flat glass panel cooled in accordance with the invention are at a temperature of 500-535° C., preferably of 510-525° C., and most preferably of 515-520° C. At the same time, the inner side of the skirt of the flat glass panel is at a temperature not lower than 445° C., preferably at a temperature of 450-480° C., and most preferably of 455-470° C. It is to be noted that it is important that the inner side of the skirt is at a temperature not lower than 445° C., and there is no limit to the upper limit of the temperature of the inner side of the skirt. Once the flat glass panel meets the requirements as to temperature indicated above, it is immediately passed onto the stud-sealing machine—optionally with the help of an overturning means, which overturns the panel upside down—for sealing studs on the inner side of the skirt of it; for that purpose, the supporting poles of the stud-sealing machine are brought to be in contact with the one or more locations on the inner surface of the flat glass panel having been subjected to forced cooling, and thus support the flat glass panel.

As to sealing studs per se, it is known in the art and can be implemented in a conventional way.

Studs are usually made of a metal, such as steel and an alloy, preferably of steel.

The flat glass panel that can be treated in accordance with the invention can be a conventional one of a conventional composition known in the art, such as a 21 inch, 25 inch, 29 inch, 34 inch and 42 inch ones of a conventional glass composition.

Moreover, the present invention provides apparatus for sealing studs on the inner side of the skirt of the flat glass panel, comprising
(1) a cooling system;
(2) a conveying belt for the flat glass panel; and
(3) a stud-sealing machine for the flat glass panel;
   characterized in that, the cooling system is equipped with a cooling gas distributor capable of directing the cooling gas towards at least one location on the inner surface of the flat glass panel.

The cooling system of the above apparatus can be the cooling system of the invention as described above, comprising a supply duct for cooling gas, a cooling gas distributor, and a conveying belt for the flat glass panel. The cooling gas distributor is capable of directing the cooling gas towards at least one location, preferably more than three locations, and most preferably four locations on the inner surface of the flat glass panel. For that purpose, it has as many nozzles for blowing cooling gas. Alongside the conveying belt for the flat glass panel is installed a removing belt, which is not coupled to, and can thus move independently of the conveying belt for the flat glass panel; the removing belt is linked with a programmable logic controller, which receives signals indicating the position of the flat glass panel and sends the signals to a solenoid to turn on or stop the supply duct for the cooling gas, and to a motor to activate or stop the removing belt; thus, the cooling gas is controlled to effect forced cooling of the flat glass panel at the desired locations on its inner surface with its inner surface facing upward for a period of time.

After the flat glass panel is cooled locally in accordance with the invention, the conveying belt for the flat glass panel passes the flat glass panel to the stud-sealing machine for the flat glass panel. The stud-sealing machine in turn—optionally with the help of a overturning means, which overturns the panel upside down and brings it to a state in which its inner surface faces downward—supports the flat glass panel, with the supporting poles in contact with the locations having been subjected to forced cooling.

The conveying belt of the apparatus is the extension of that of the cooling system. In other words, the conveying belt of the cooling system and that of the apparatus make up a whole conveying belt.

As the conveying belt, the overturning means and the stud-sealing machine, any conventional ones known in the art can be employed to the extent that they can achieve the respective purposes.

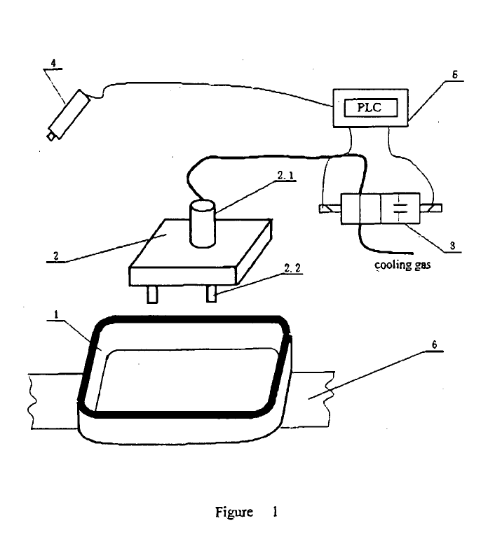

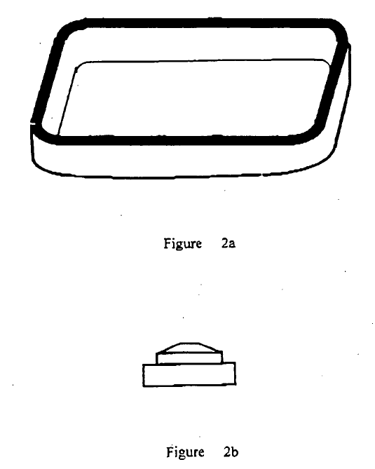

Now referring to FIG. 1, a schematic view of the cooling system of the invention, a flat glass panel 1 with its inner surface facing upwards, moved by and on the conveying belt 6, is subjected to forced cooling at four locations with a cooling gas distributor 2. The cooling gas distributor 2, installed over the conveying belt 6, comprises an cooling gas inlet 2.1 and four gas nozzles 2.2 (only two shown in the figure), with the nozzles 2.2 directed to the locations to be subjected to forced cooling. The cooling gas inlet 2.1 is linked to a supply duct for cooling gas 3. The supply duct for cooling gas 3 is equipped with a solenoid in itself and through the solenoid is controlled by a programmable logic controller (PLC) 5, thus turning on or stopping the cooling gas. A photosensor 4 is provided to detect the position of the panel 1, and sends the signal of the position of panel 1 to the PLC 5. Once the panel 1 reaches the stud-sealing machine (not shown in the figure), the photosensor 4 detects its position and sends a signal of its position to the PLC 5; in response to the signal, the PLC 5 controls the solenoid installed in the supply duct for cooling gas 3 to stop the flow of cooling gas through duct 3, thus terminating forced cooling at the locations on the inner surface of the flat glass panel 1. Immediately, for the purpose of carrying out the step of sealing studs on the inner side of the skirt of the flat glass panel, the PLC 5 instructs the conveying belt 6—optionally with the help of an overturning means (not shown in the figure)—to pass the panel 1 to the stud-sealing machine (not shown) with the locations subjected to forced cooling in contact with the supporting poles of the stud-sealing machine.

### EXAMPLES

The following examples are intended to further illustrate the invention without limiting it in any way.

In the examples, the depression ratio of a flat glass panel product with sealed studs is defined as follows:
Depression ratio=(The number of panel products with depression at the locations having been in contact with the supporting poles of the stud-sealing machine/The number of panel products without depression at the locations having been in contact with the supporting poles of the stud-sealing machine)×100%

Additionally, the ratio of crack and rupture of a flat glass panel product with sealed studs is defined as follows:
Ratio of crack and rupture=(The number of panels with crack and rupture/The number of panels without crack and rupture)×100%

### Comparative Example 1

A 25 inch flat glass panel, after being molded, was subjected to natural Cooling, without being subjected to forced cooling in accordance with the present invention. The four locations expected to be in contact with the supporting poles of the stud-sealing machine were cooled to a temperature of 520° C. and, at the same time, the inner side of the skirt of the panel was cooled to 430° C. Then the step of sealing studs was carried out, leading to a depression ratio of 0%, and a ratio of crack and rupture of 10%.

### Comparative Example 2

A 29 inch flat glass panel, after being molded, was subjected to natural Cooling, without being subjected to forced cooling in accordance with the present invention. The four locations expected to be in contact with the supporting poles of the stud-sealing machine were cooled to a temperature of 538° C. and, at the same time, the inner side of the skirt of the panel was cooled to 445° C. Then the step of sealing studs was carried out, leading to a depression ratio of 5.0%, and a ratio of crack and rupture of 0.97%.

### Example 1

A 25 inch flat glass panel, after being molded, was subjected to forced cooling at four locations on the inner surface in accordance with the present invention. For each location to be cooled, the cooling gas blew at a flow rate of 52 m³/hour for 6 seconds. The four locations that were to be in contact with the supporting poles of the stud-sealing machine were cooled to a temperature of 520° C. and, at the same time, the inner side of the skirt of the panel was cooled to 445° C. Then the step of sealing studs was carried out, yielding a depression ratio of 0%, and a ratio of crack and rupture of 1.0%.

### Example 2

A 21 inch flat glass panel, after being molded, was subjected to forced cooling at four locations on the inner surface in accordance with the present invention. For each location to be cooled, the cooling gas blew at a flow rate of 55 m³/hour for 4 seconds The four locations that were to be in contact with the supporting poles of the stud-sealing machine were cooled to a temperature of 518′ and, at the same time, the inner side of the skirt of the panel was cooled to 450° C. Then the step of sealing studs was carried out, yielding a depression ratio of 0%, and a ratio of crack and rupture of 0.83%.

### Example 3

A 29 inch flat glass panel, after being molded, was subjected to forced cooling at four locations on the inner surface in accordance with the present invention. For each location to be cooled, the cooling gas blew at a flow rate of 46 m³/hour for 5 seconds. The four locations that were to be in contact with the supporting poles of the stud-sealing machine were cooled to a temperature of 525° C. and, at the same time, the inner side of the skirt of the panel was cooled to 448° C. Then the step of sealing studs was carried out, yielding a depression ratio of 0%, and a ratio of crack and rupture of 0.85%.

### Example 4

A 34 inch flat glass panel, after being molded, was subjected to forced cooling at four locations on the inner surface in accordance with the present invention. For each location to be cooled, the cooling gas blew at a flow rate of 40 m³/hour for 7 seconds. The four locations that were to be in contact with the supporting poles of the stud-sealing machine were cooled to a temperature of 528° C. and, at the same time, the inner side of the skirt of the panel was cooled to 446° C. Then the step of sealing studs was carried out, yielding a depression ratio of 0%, and a ratio of crack and rupture of 1.0%.

1. A cooling system for the inner surface of the flat glass panel of CRT, comprising
(1) a supply duct for cooling gas;
(2) a cooling gas distributor; and
(3) a conveying belt for the flat glass panel; characterized in that, the cooling gas distributor is capable of directing the cooling gas towards the locations on the inner surface of the flat glass panel that are to be in contact with the supporting poles of the stud-sealing machine; alongside the conveying belt for the flat glass panel is installed a removing belt, which is not coupled to the conveying belt for the flat glass panel; the removing belt is linked with a programmable logic controller, which receives signals from the removing belt and transmits them to a solenoid; the solenoid turns on or closes the supply duct for the cooling gas.

2. The cooling system according to claim 1, wherein that the cooling gas distributor is equipped with four cooling gas nozzles directed downwards to the locations on the inner surface of the flat glass panel that are to be in contact with the supporting poles of the stud-sealing machine.

3. The cooling system according to claim 1, wherein the solenoid turns on or closes the supply duct for the cooling gas in accordance with the time required for cooling the inner surface of the flat glass panel.

4. A process for sealing studs on the inner side of the skirt of a flat glass panel, comprising
(1) carrying out forced cooling at one or more locations on the inner surface of the flat glass panel;
(2) supporting the flat glass panel at one or more locations cooled as in (1) with one or more supporting poles of the stud-sealing machine; and
(3) sealing studs onto the inner side of the skirt of the flat glass panel.

5. The process according to claim 4, wherein said one or more locations on the inner surface of the flat glass panel is cooled to 500-535° C.

6. The process according to claim 4, wherein the inner side of the skirt of the flat glass panel is cooled to a temperature not lower than 445° C.

7. The process according to claim 4, wherein for each location, the cooling gas blows at a flow rate of 20-90 m³/hour.

8. The process according to claim 7, wherein the cooling gas is air.

9. The process according to claim 4, wherein the duration of time for blowing cooling gas is less than 10 seconds.

10. Apparatus for sealing studs on the inner side of the skirt of the flat glass panel, comprising
(1) a cooling system;
(2) a conveying belt for the flat glass panel; and
(3) a stud-sealing machine for the flat glass panel;
characterized in that, the cooling system is equipped with a cooling gas distributor capable of directing the cooling gas towards at least one location on the inner surface of the flat glass panel.
